(19) United States
(12) Patent Application Publication
(10) Pub. No.: US 2013/0012224 A1
(43) Pub. Date: Jan. 10, 2013

(54) METHOD AND DEVICE FOR REDUCING INTERFERENCE AMONG FEMTOCELLS IN AN ACCESS DEVICE OF A FEMTOCELL

(76) Inventors: Feng Yang, PuDong Jinqiao Shanghai (CN); Jigang Qiu, PuDong Jinqiao Shanghai (CN)

(21) Appl. No.: 13/637,090

(22) PCT Filed: Mar. 25, 2011
(86) PCT No.: PCT/IB2011/000929

§ 371 Date: Sep. 25, 2012

(30) Foreign Application Priority Data
Mar. 25, 2010 (CN) 201010132767.1

(51) Int. Cl. H04W 72/04

(52) U.S. Cl. 455/452.1

(57) ABSTRACT

The present invention provides a method for reducing interference among Femtocells in a first access device of a first Femtocell, comprising the following steps: a receiving step, wherein said first access device receives a first wireless signal periodically transmitted by a second access device of a second Femtocell, and said first wireless signal comprises characteristic information of said second access device; a judging step, wherein said first access device judges whether the level of said first wireless signal exceeds a first pre-determined threshold and interferes at least one user terminal in said first Femtocell; a first executing step, wherein if the level of said first wireless signal exceeds said pre-determined threshold and interferes said at least one user terminal in said first Femtocell, said first access device creates a cooperative working mode between said first access device and said second access device by interacting with said second access device, so as to reduce interference between said first Femtocell and said second Femtocell.

### FIELD OF THE INVENTION

The present invention relates to a scheme for reducing interference among cells, especially to a method and a device for reducing interference among Femtocells in an access device of a Femtocell.

### BACKGROUND OF THE INVENTION

Nowadays, Femtocell has been paid more and more attention to by network operators and their vendors since it can increase system capacity and enlarge indoor coverage. In Femtocell techniques, end users use access points (APs) as access devices at home or office. These access devices are accessed to core network via for example digital user line (DSL). Because most of traffic is delivered via backhaul, the spectrum resources at the air interface between access devices and user terminals are spared and can be used for real mobile services. On the other hand, because the access devices in Femtocell are often close to the user terminals, effective coverage of wireless signal can be realized with very limited power.

Due to the above various advantages of Femtocell techniques, corresponding extension of related standards is already underway. For example, IEEE 802.16m has been defined WiMAX Femto AP (WFAP), and 3GPP also defines home eNodeB (HeNB). HeNB communicates with user terminals based on LTE or LTE-A standard so that it is not necessary for user terminals to have multi-mode function and the cost is effectively controlled.

However, there are still some problems to solve in Femtocell techniques, for example:

1) As the access device such as an AP is installed by end users individually, the cell planning is impossible. Thus, this characterization of Femtocell makes it difficult to reduce interference by means of Femtocell planning.

2) Mutual interference among adjacent access devices is difficult to be avoided, because the original introduction of Femtocell access device is mainly for the purpose of solving the problem of indoor signal coverage.

The existing technology provides some solutions for avoiding inference among Femtocells. According to an existing solution, after a user buys a Femtocell access device, the network address such as IP address or MAC address used by the access device will be registered in network. Thereafter, these network addresses are forwarded to a Femtocell proxy server, and a variety of parameters including wireless transmit power etc. will be configured by the proxy server according to the address information provided by all end users. This solution has obvious drawbacks. Firstly, the network address used by the access device is possible to change, for example due to a relocation installation caused by the end user's movement. In this case, the end user has to re-register the new network address of the access device at the proxy server at network side, resulting in less flexibility and worse user experiences. Secondly, because the Femtocell proxy server configures the parameters almost without knowing the particular network condition of the access device, the finally configured parameters are often highly conservative. Taking the discussed access device as an example, the proxy server assigns it less wireless transmit power so as to avoid interfering Femtocells served by other access devices, even if no other access device around this access device is in operation. This is obviously disadvantageous to resource optimization. Moreover, even if the wireless transmit power of the access device is controlled, the interference among Femtocells is not necessarily solved effectively.

According to another existing solution, in order to reduce interference among Femtocells, a dynamic power control (DPC) mechanism is defined in both uplink and downlink at air interface between access device and user terminals, in which the access device limits its own transmit power below a threshold, and once its actual transmit power exceeds this threshold, this access device will believe that it is interfering other Femtocells around it and will adjust its transmit power below this threshold. Especially under a dense deployment of Femtocell network, such power control way is helpful to reducing interference among Femtocells, but it is at the cost of reduced quality of service (QoS) and throughput.

### SUMMARY OF THE INVENTION

The disclosure of the present invention is based on the recognization of the following technical problems:

Firstly, in all kinds of solutions in the prior art, the scheme for reducing interference among Femtocells does not depend on a sensing performed by the access device for the network environment where it locates, which results in aimless control of performance and parameters of access device in all aspects. Due to such aimlessness, conservative control way has been widely used such that the system performance degrades to a great extent. A return therefore is a reduction of the interference which may not exist. In other words, the discussion about reducing interference should be under the assumption that there exists at least one interfered object. Therefore, preferably, an interference source makes some actions purposefully and effectively according to indications from the interfered part. This will be described in detail in the following.

According to an embodiment of the present invention, there is provided a method for reducing interference among Femtocells in a first access device of a first Femtocell, comprising the following steps: a receiving step, wherein, said first access device receives a first wireless signal which is periodically transmitted by a second access device of a second Femtocell, and said first wireless signal comprises characteristic information of said second access device; a judging step, wherein, said first access device judges whether the level of said first wireless signal exceeds a first pre-determined threshold and interferes at least one user terminal in said first Femtocell; a first executing step, wherein, if the level of said first wireless signal exceeds said pre-determined threshold and interferes said at least one user terminal in said first Femtocell, said first access device creates a cooperative working mode between said first access device and said second access device by interacting with said second access device so as to reduce interference between said first Femtocell and said second Femtocell.

According to another embodiment of the present invention, there is provided a first apparatus for reducing interference among Femtocells in a first access device of a first

Femtocell, comprising: a receiver, for receiving a first wireless signal which is periodically transmitted by a second access device of a second Femtocell, wherein said first wireless signal comprises characteristic information of said second access device; a first unit, for judging whether the level of said first wireless signal exceeds a first pre-determined threshold and interferes at least one user terminal of said first

Femtocell; a second unit, for creating a cooperative working mode between said first access device and said second access device by interacting with said the second access device so as to reduce interference between said first Femtocell and said second Femtocell, if the level of said first wireless signal exceeds said pre-determined threshold and interferes said at least one user terminal of said first Femtocell.

By using the above-mentioned method and first apparatus, the Femtocell access device can sense the condition and change of the surrounding wireless environment in time so as to dynamically adjust its wireless parameters to optimize system performance. In addition, when serious interference appears, the access device can reduce the interference by creating the cooperative working mode, and the interference can be transformed into useful signal with the help of an advantageous cooperative mode.

### BRIEF DESCRIPTION OF THE DRAWINGS

By reading the detailed description of the non-limiting embodiments with reference to the following drawings, other objects, features and advantages of the present invention will become apparent.

FIG. 1 shows a typical application scenario of the present invention;

FIG. 2 shows a flow diagram of a method for reducing interference among Femtocells in an access device according to an embodiment of the present invention;

FIG. 3 shows a flow diagram of a system method for reducing interference among Femtocells according to an embodiment of the present invention;

FIG. 4 shows a structural block diagram of an apparatus for reducing interference among Femtocells according to an embodiment of the present invention.

The same or similar reference signs refer to the same or procedure features or apparatus/module.

### DETAILED DESCRIPTION OF EMBODIMENTS

Here at least one embodiment of the method and apparatus of the present invention as shown in the drawings will be mentioned. It should be understood that these embodiments are illustrated by explaining each aspect of the present invention, but should not be understood as limits to the present invention. For example, features shown or illustrated as a part of one embodiment may be used in another embodiment so as to get another embodiment. The present invention covers these embodiments as well as all kinds of varieties which fall into the scope and spirit of the present invention.

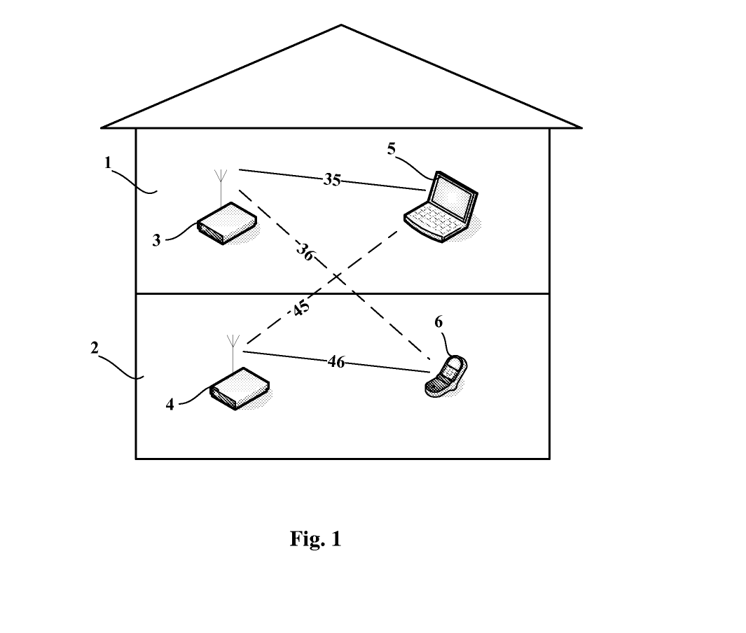

FIG. 1 shows a typical scenario of the method and apparatus provided by the present invention, showing a part of a residential building, wherein, unit 1 locating at the upper floor of unit 2 is installed with Femtocell access device 3 and unit 2 is installed with Femtocell access device 4. Access device 3, 4 are installed somewhere at home by users according to their actual requirements and the positions can be adjusted as required. In the figure, they are shown as being in the similar positions in units 1 and 2 only for the clarity of the drawing.

The concept of Femtocell is firstly explained previous to discussing the problem of interference among Femtocells in detail. According to the existing theory in the field, a Femtocell is an area covered and managed by an access device and is similar to a cell covered and managed by a base station in the traditional wireless communication network. The Femtocell is much smaller in terms of range of the coverage than the traditional cell. Only for the purpose of describing the particular embodiment more vividly, it is considered that the installation of the access devices such as access device 3 is mainly for meeting the use requirement in unit 1 and its original intention does not include serving user terminals outside unit 1. Therefore, the same reference signs are used for the Femtocells and the units in the example shown in FIG. 1. As a result, the Femtocell managed by access device 3 is also called Femtocell 1, and similarly, the Femtocell managed by access device 4 is called Femtocell 2.

In FIG. 1, there is user device 5 such as a notebook, also called computer 5, in Femtocell 1, and the wireless link between it and access device 3 is referred to as the combination of their reference signs, namely 35. There is user device 6 in unit 2 such as a mobile phone, also called mobile 6, and the wireless link between it and access device 4 is referred to as the combination of their reference signs, namely 46. According to the traditional Femtocell techniques, link 35 and 46 are desired or contributive links, but link 36 and 45 are the links which are undesired or not contributive or even causes interference. To be specific, when access device 3 sends a signal to computer 5, and if access device 4 sends a signal to mobile 6 at this moment as well, the signal in link 36 represented by a dotted line constitutes the interference to the signal in useful link 46 due to the frequency reuse among Femtocells, and correspondingly, the signal in link 45 constitutes the interference to the signal in useful link 35. Certainly, some interference is strong and some is weak, which will be discussed in the following.

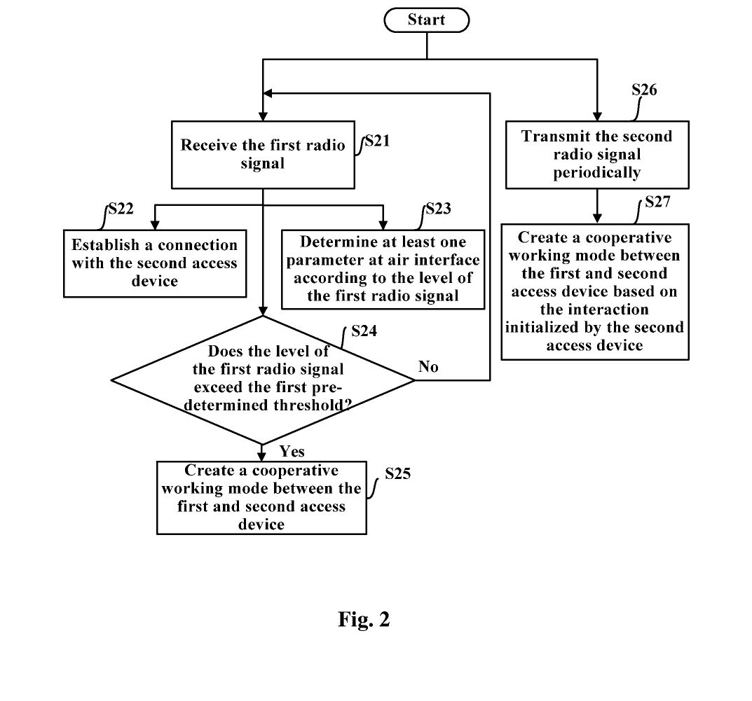

Referring to FIG. 2 showing a flow diagram of a method for reducing interference among Femtocells in an access device according to an embodiment of the present invention and describing access device 3 shown in FIG. 1, the skilled in the art knows that the same features and procedures are applicable to access device 4 as well. Due to the symmetry between access devices, when an access device is discussed, this access device is a first access device which is called and the Femtocell managed by it is a first Femtocell, while each of its adjacent access devices can be regarded as a second access device in a second Femtocell, and vice versa. In addition, a wireless signal which is transmitted by the first access device and can be used to sense the first access device and obtain the level of the signal is called a second ratio signal, the wireless signal received by the first access device for sensing the second access device and obtaining the level of the signal is called a first wireless signal. The relationship and difference of these concepts will become clearer in the following.

As mentioned above, each access device needs to transmit some signals to be sensed by transmitters in order to make adjacent access devices know its existence and be able to determine interference level. According to different embodiments of the present invention, such kind of signals may be downlink signals transmitted to user terminals as well as signaling signal to be dedicatedly provided to other access device. In particular, in step 26, access device 3 periodically transmits the second wireless signal comprising characteristic information of access device 3, for example MAC address, hardware number, IP address or other identifying information.

Executing of step S26 is mainly for realizing, for example, sensing the first access device namely access device 3 and detecting signal level by other access devices such as access device 4. Similarly, other access devices also transmit such wireless signal, wherein the first wireless signal transmitted by the second access device such as access device 4 comprises characteristic information of access device 4.

Because downlink signal transmitted by a access device to user terminals normally does not carry characteristic information of the access device, access device 4 adds its own characteristic information in a pre-determined position of downlink signal at regular intervals, for example 10 frames, in order to use this kind of downlink signal to realize sensing among devices, By pre-configurations, access device 3 can “overhear” downlink signal from access device 4 and at least obtain the part of signal carrying characteristic information of access device 4. For example, the “overhearing” is carried out every 10 frames. When the first wireless signal is not normal downlink signal but a signal dedicatedly used for mutual sensing among access devices, the problem might become simpler. Based on pre-configurations for each access device, the second access device such as access device 4 will transmit the first wireless signal in a dedicated channel and add its own characteristic information into the first wireless signal. Likewise, based on pre-configuration, the first access device such as access device 3 can receive this signal and obtain the characteristic information of access device 4 from it so as to determine who has transmitted this first wireless signal.

According to an embodiment of the present invention, taking access device 3 as an example, it may use its inherent antenna/antennas to transmit the second wireless signal and receive the first wireless signal. Alternatively, access device 3 is equipped with dedicated antenna/antennas to receive and transmit the above-mentioned signals.

The above-mentioned first and second wireless signal are received and transmitted via air interface of access devices. However, considering that this air interface is mainly used for communication between access devices and user terminals, other communication process among access devices will be all realized via backhaul according to an embodiment of the present invention in order to reduce the occupation of the valuable wireless resources. In particular, in step S22, a connection based on IP protocol is established between access device 3 and 4 with the help of characteristic information of access device 4. If the characteristic information of access device 4 included in the first wireless signal is not IP address but MAC address or hardware number, access device 3 will access an auxiliary address device, for example a route, in which a map between MAC address or hardware number and IP address of each access device is pre-stored, and establish the above-mentioned connection after finding the IP address of access device 4.

Step S22 will particularly happen at the time when access device 3 or 4 is just switched on and being initialized, because they do not sense the existence of the other part, and thus, the connection over backhaul will be established after they sense the existing of the other part. Because the first and second wireless signal are transmitted periodically, in the case that the connection over backhaul has been established, access device 3 need not re-establish the backhaul connection with access device 4 but only keep this connection active after access device 3 has received the first wireless signal.

The established connection between access device 3 and 4 is not always active. For example, the user in unit 2 switches off access device 4 when leaving for work, and thus, access device 3 certainly will not receive any first wireless signal transmitted by access device 4 until access device 4 is switched on again. When access device 3 does not receive the first wireless signal from access device 4 during a certain time interval, it will remove the connection previously established and consider access device 4 as not existing.

Further, step S22 may be related to the level of the first wireless signal. In particular, a second pre-determined threshold is pre-set in access device 3 and corresponds to the level of the first wireless signal. As a result, after having received the first wireless signal, access device 3 determines the level of the received signal represented, for example, by received signal strength indicator (RSSI), and then compares it with the second pre-determined threshold. If the level of the first wireless signal is relatively strong and exceeds the second pre-determined threshold, it means that it is very possible for access device 4 to cause high interference to Femtocell 1. On the contrary, if the level of the first wireless signal is common and does not exceed the second pre-determined threshold, it means that it is perhaps of low possibility that access device 4 causes interference to Femtocell 1. As a result, especially when the number of the connections over backhaul is limited, access device 3 preferably establishes connections over backhaul only with those access devices which transmit the first wireless signal whose level exceeds the second pre-determined threshold. Certainly, an access device previously determined as not being a potential strong interference source may be determined as a potential strong interference source later, because the transmit power at air interface of each access device may change over time. For example, the transmit power is increased to guarantee quality of service (QoS), and vice versa.

It should be understood that step S22 may be omitted, because it is a preparation, namely that it establishes an active connection with an interference source over backhaul which is not sensitive to signaling overhead before unaffordable interference does not actually happen yet such that in the following working process, once a strong interference source is detected, it immediately interacts with the interference source via the established connection without occupying any resource of air interface. As a simple alternative way, the first wireless signal is transmitted periodically, and thus, when access device 3 detects that the existence of access device 4 at its power-on, it does not in a hurry to establish a connection between the two, but will establish the connection over backhaul to interact only after extracting characteristic information of the interference source, namely access device 4, from the interference signal when access device 4 actually interferences a certain user terminal in Femtocell 1 later. This and other alternative ways will be described in more detail in the following.

Next, step S23 is discussed. In particular, at least one parameter of access device 3 at air interface may also be determined with reference to the level of the first wireless signal. When the first wireless signal is dedicated to the sensing among access devices and signal detection, the transmit power of this signal may be fixed, e.g. Px, and as a result, access device 3 knows what the actual level of the signal transmitted with such transmit power Px is when it arrives at access device 3. Based on the assumption that the channel between access device 3 and 4 is symmetrical or substantially symmetrical, access device 3 can approximately estimate what the interference level applied to Femtocell 2 by the signal transmitted by access device 3 is if the access device 3 takes Px as its transmit power. As a relatively conservative way, if the received level of the first wireless signal is strong, obvious interference is caused when there are user terminals occupying the same time-frequency resources in Femtocell 1 and 2, and access device 3 will determine initial transmit power lower than Px. As a result, when a user terminal such as computer 5 requests access later, access device 3 will transmit wireless downlink signal to computer 5 with transmit power lower than Px. Certainly, because access device 3 does not know whether there is user terminal which uses the same time-frequency resources with computer 5 in Femtocell 2, it can thus be seen that the way in which access device 3 enforces itself to use lower initial transmit power is conservative. To the contrary, if the signal level has been attenuated to a relatively low or negligible level when the first wireless signal transmitted with transmit power Px arrives at access device 3, access device 3 may roughly determine that when access device 3 transmits downlink signal with transmit power Px, it will not cause interference with considerable level to Femtocell 2 even if there are user terminals which occupy the same time-frequency resources in Femtocell 1, 2, respectively. Therefore, after computer 5 requests access, the transmit power with which access device 3 transmits wireless downlink signal to computer 5 may be equal to or slightly greater than Px.

Step S24 and step S25 are more inclined to the case that two access devices provide access for user terminals managed by them, respectively. Likewise, steps S24 and S25 are also based on the measurement of the level of the first wireless signal which is transmitted periodically. In particular, in step S24, access device 3 judges whether the level of the first wireless signal exceeds a first pre-determined threshold and will interference at least one user terminal in Femtocells. There are several ways to implement this judgment, which are introduced as below, respectively:

24.1) In theory, interference is created under the assumption of the reuse of transmission resource such as time-frequency resource blocks among Femtocells. Therefore, access device 3 not only considers the level of the first wireless signal but also judges whether this first wireless signal really causes interference to at least one user terminal in Femtocell 1. In this case, the first wireless signal is normally downlink signal transmitted from access device 4 to a certain user terminal such as mobile 6 in Femtocell 2, but carries the characteristic information of access device 4 therein. As a result, if the level of the first wireless signal exceeds the first pre-determined threshold and mobile 6 to which the first wireless signal directed actually uses the same time-frequency resource blocks with at least one user device served by access device 3, for example computer 5. Therefore, the first wireless signal is an interference signal which has to be considered.

Certainly, the above interference among Femtocells is created as access device 3, 4 simultaneously transmit downlink signals to computer 5 and mobile 6 managed by them, respectively. Therefore, access device 3 may be equipped with two sets of antennas in order to receive the above-mentioned first wireless signal while transmitting downlink signal to computer 5.

24.2) As an easy implementing way of step S24, access device 3 only considers the level of the first wireless signal, and obtains the judgment result in step S24 according to the relationship between the level of the first wireless signal and the first pre-determined threshold.

If the judgment result in step S24 is negative, the method will go back before step S21, namely waiting for receiving the next first wireless signal, which is not repeated.

To the contrary, if the judgment result in step S24 is positive, the method will go into step S25 which is to be described in detail hereinafter.

In view of the problem that Femtocell 2 is applying strong interference to Femtocell 1, step S25 can be realized in different ways according to different embodiments of the present invention, as below:

Embodiment 1: access device 4 uses beamforming scheme to reduce interference to computer 5.

According to Embodiment 1, access device 4 is required to be equipped with multiple transmit antennas and generates a beam with directivity by means of these antennas to concentrate the energy in the direction pointing to mobile 6, to enhance signal quality and to reduce the interference to computer 5. Considering the characterization of beamforming, the beamforming technique is not the best choice when computer 5 and mobile 6 roughly locate in the same direction with respect to access device 4. Information such as channel status information required by access device 4 to make beamforming may be provided by access device 3 via an IP connection previously established over backhaul. If no IP connection between the two is established previously, access device 3 may eventually establish such connection according to the characteristic information of access device 4 in the first wireless signal. It should be understood that the advantage of using backhaul to make more information interactions among access devices, it is not excluded that the interactions among access devices are made in a wireless manner.

Embodiment 2: access devices 3, 4 perform downlink transmission for computer 5 and mobile 6 by means of multi-base station (Multi-BS) pre-coding.

According to Embodiment 2, access devices 3, 4 perform joint pre-coding, wherein access devices 3 may collect the status information of channel 35, 45, 36, 46, generate pre-coding matrix, and provide access device 4 with corresponding vector/vectors. Such Multi-BS pre-coding technique may enable access devices 3, 4 to each serve computer 5 and mobile 6 simultaneously, or may enable access device 3 to serve computer 5, access device 4 to serve computer 6 while reducing the interference to computer 5 by, for example, generating a null in the direction of computer 5 by means of pre-coding.

Embodiment 3: access devices 3 re-schedules computer 5 so that computer 5 avoids interference from access device 4.

According to Embodiment 3, there is more than one downlink resource block which access devices 3 can allocate. For example, computer 5 is originally scheduled on time-frequency resource block T1F1, and now, because this resource block has been used in adjacent Femtocell and the signal level is relatively strong, the interference is avoided by scheduling computer 5 on T2F1 or T2F1 or T2F2 etc. to separate computer 5 and mobile 6 in at least one of time domain and frequency domain. This scheme reduces the interference at the cost of more resource utilization.

Embodiment 4: access devices 4 re-schedules mobile 6 to avoid causing interference to computer 5

Embodiment 4 shares the same concept with Embodiment 3, but now it is access device 4's turn to re-schedule user terminals, for example from T1F1 to T2F1. In practice, different access devices or different Femtocells may have different priorities. In the case that step S25 needs to be executed, such re-scheduling is always performed by the access device with lower priority. Without loss of generality, the access device having the largest amount of allocatable resources may be assigned with relatively low priority. For example, an access device has 200M allocatable downlink bandwidth while another access device has only 10M, and the former is preferably selected to perform re-scheduling.

Alternatively, the access device having more remaining resource to allocate may be assigned with relatively low priority.

Embodiment 5: access device 4 reduces the transmit power when transmitting downlink signal to mobile 6, so as to reduce the reference to computer 5.

Optionally, after access devices 3 judges that the level of the first wireless signal exceeds the first pre-determined threshold, it may inform access device 4 about this information in an IP link, and accordingly, access device 4 reduces the power allocation on the time-frequency resource block such as T1F1 corresponding to the first wireless signal, so as to avoid the interference to computer 5.

In practice, it may happen that The QoS in link 46 degrades rapidly after access device 4 reduces the transmit power when transmitting downlink signal to mobile 6, and if hybrid automatic repeat request (HARM) technique is used at air interface of access device 4, mobile 6 will frequently request access device 4 to retransmit downlink data. In view of the overall system, this guarantees that Femtocell 1 is not interfered, but the cost is the influence on the traffic of mobile 6. For this reason, after being aware of the above-mentioned status of the QoS of link 46, access device 4 interacts with access device 3 again and changes the cooperative way between them, for example into any way in Embodiments 1-3. Certainly, if access device 4 is changed into the way in Embodiment 4, it performs re-scheduling without interacting with access device 3.

Step S27 in FIG. 2 is a subsequent step after the second wireless signal transmitted by access device 3 is determined by other devices such as access device 4 as possibly causing interference. Here, access device 3 plays the same role as access device 4 in all the above embodiments while access device 4 plays the same role as access device 3 in all the above embodiments, which is not repeated.

In the existing Femtocell techniques, access devices widely use closed subscriber group (CSG) as an admission mode. The combination of the present invention and CSG will be described in the following with reference to a particular example.

There are only two adjacent Femtocells in the examples discussed above, but the skilled in the art can apply the present invention to the case that there are multiple adjacent Femtocells by reading the content of this application without any creative effort. Moreover, the case of multiple adjacent Femtocells is also covered by the present invention.

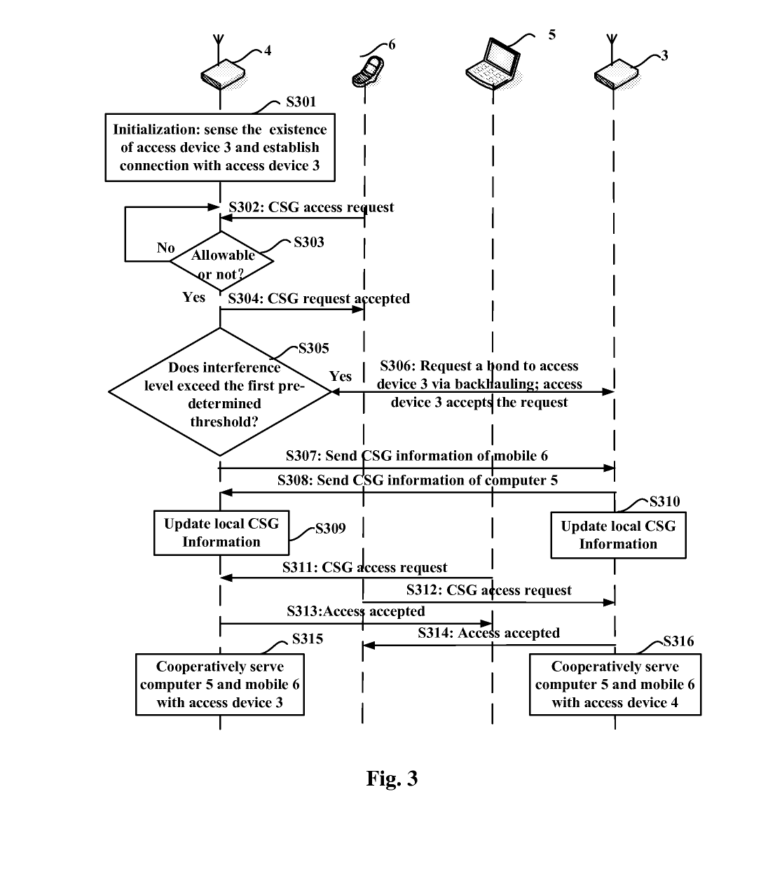

Next, the embodiments of the present invention is described in view of system by referring to FIG. 3 and combining FIG. 1, wherein the role of access device 4 is equivalent to a first access device, and access device 3 is a second access device with respect to access device 4.

Step S301: access device 4 is switched on, receives a first wireless signal from access device 3 for the first time after the power-on and thus detects the existing of adjacent access device 3, namely establishing an IP connection with access device 3 over backhaul.

Step S302: mobile 6 requests to access to access device 4 to receive downlink data.

Step S303: access device 4 judges whether mobile 6 is in a pre-stored CSG list.

Step S304: if mobile 6 is in the pre-stored CSG list of access device 4, access device 4 will accept this access request.

Step S305: subsequently, access device 4 still monitors the level of the first wireless signal transmitted by access device 3 and compares it with a first pre-determined threshold.

Step S306: if the level of the first wireless signal exceeds the first pre-determined threshold, it is necessary for access device 4 to create a cooperative working mode with access device 3. Therefore, access device 4 firstly requests a bond from access device 3. After receiving the bonding request from access device 4, access device 3 determines that the downlink transmission of Femtocell 1 has influenced Femtocell 2, and then accepts this bonding request.

Steps S307-S308: in order to meet the authorization requirements of CSG, access device 3, 4 exchange CSG information of mobile 6 and computer 5.

Step S309: access device 4 adds the received information of computer 5 into the local CSG list so that computer 5 becomes one of the user terminals which can be temporarily allowed to access to access device 4.

Step S310: access device 3 adds the received information of mobile 6 into the local CSG list so that mobile 6 becomes one of the user terminals which can be temporarily allowed to access to access device 3.

Steps S311-S312: subsequently, computer 5 initiates an access request to access device 4, and mobile 6 initiates an access request to access device 3.

Steps S313-S314: based on the updated CSG list, access devices 3, 4 accept the access requests from access from mobile 6 and computer 5 respectively.

Steps S315-S316: subsequently, access devices 3, 4 may process the downlink transmission to mobile 6 and computer 5 based on various schemes for serving multiple user devices by multiple network devices such as base stations that now exist or are developed in the future such as Multi-BS pre-coding technique, thereby solving the problem of mutual interference between Femtocell 1 and 2.

After all embodiments of the method provided by the present invention are introduced, the first apparatus provided by the present invention will be briefly described with reference to the above description for the embodiments of the method as follows.

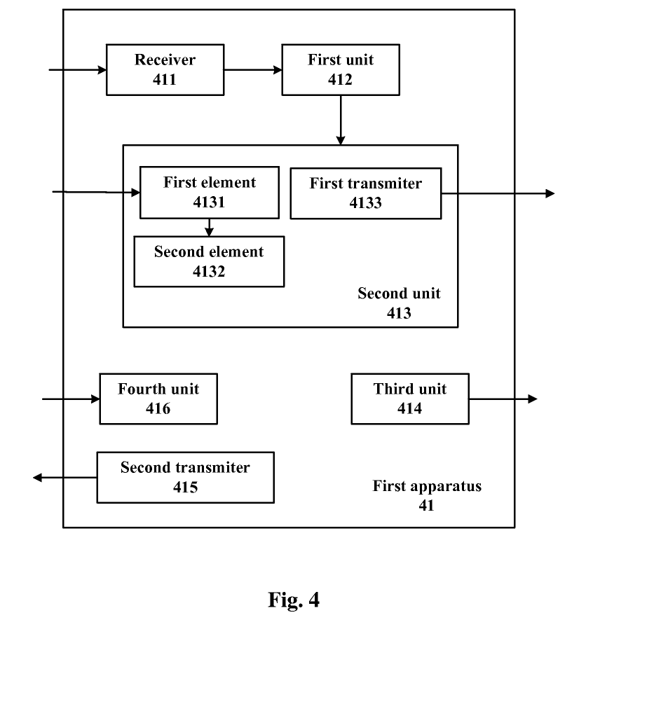

Refer to FIG. 4 showing a block diagram of the first apparatus 41 for reducing interference among Femtocells in a first access device of a first Femtocell, which comprises:

Receiver 411, for receiving a first wireless signal which is periodically transmitted by a second access device of a second Femtocell, wherein said first wireless signal comprises characteristic information of said second access device. It corresponds to the above step S21.

First unit 412, for judging whether the level of said first wireless signal exceeds a first pre-determined threshold and interferes at least one user terminal of said first Femtocell. It corresponds to the above step S24.

Second unit 413, for creating a cooperative working mode between said first access device and said second access device by interacting with said the second access device, so as to reduce the interference between said first Femtocell and said second Femtocell, if the level of said first wireless signal exceeds said pre-determined threshold and interferes said at least one user terminal of said first Femtocell. It corresponds to the above step S25.

Further, first apparatus 41 also comprises third unit 414 for establishing a connection between said first and second access device over backhaul according to the characteristic information of the second access device in the first wireless signal. It corresponds to the above step S22.

Said second unit 413 is further used for creating a cooperative working mode between said first access device and said second access device by interacting with said the second access device, so as to reduce interference between said first Femtocell and said second Femtocell, if the level of said first wireless signal exceeds said pre-determined threshold and interferes said at least one user terminal of said first Femtocell. It corresponds to the above step S25.

Further, the above-mentioned cooperative working mode comprises at least one of the following: said second access device uses a beamforming scheme to reduce the interference to said at least one user terminal; said first access device, said second access device, said at least one user terminal and other user terminals of said second Femtocell which occupy the same transmission resources as said at least one user terminals perform downlink transmission using Multi-BS MIMO (Multi-input Multi-output); said first access device re-schedules said at least one user terminal so as to avoid the interference from said second access device; said second access device re-schedules said other user terminals so as to avoid interfering said at least one user terminals; said second access device reduces transmission power when transmitting signals to said other user terminals so as to reduce interference to said at least one user terminal.

Further, the first access device uses closed subscribe group to control the access at its air interface. Second unit 413 comprises: first element 4131 for obtaining characteristic information of each user terminal in said second Femtocell, which corresponds to the above step S307 when taking access device 3 in FIG. 1 as an example; second element 4132 for adding said characteristic information of each user terminal of said second Femtocell into the closed subscribe group controlled by said first access device, which corresponds to the above step S310.

Further, the second access device uses closed subscribe group to control the access at its air interface. Second unit 413 comprises: first transmitter 4133, for transmitting characteristic information of each user terminal in said first Femtocell to the second access device so that said second access device updates the closed subscribe group used by said second access device accordingly, which corresponds to the above step S308 when taking access device 3 in FIG. 1 as an example.

Further, first apparatus 41 further comprises: second transmitter 415 for periodically transmitting a second wireless signal which comprises characteristic information of said first access device, which corresponds to the above step S26.

Further, first apparatus 41 further comprises: fourth unit 416 for creating a cooperative working mode between said first access device and said second access device based on an interaction initiated by said second access device, so as to reduce the interference between said first Femtocell and said second Femtocell, which corresponds to the above step S27.

For the skilled in the art, it is obvious that the present invention is not limited to the details of the above exemplary embodiments, and the present invention can be realized in other specific forms without departing from the spirit or basic features of the present invention. Therefore, in all aspects, the embodiments should be regarded as illustrative and non-limiting. The scope of the present invention is defined by the appended claims rather than the above description and the invention is intended to embrace all modifications fairly falling within the meaning and scope of the claims under the doctrine of equivalents. Any reference signs in the claims should not be regarded as limiting the involved claims. Further, it is obvious that the term “comprise” does not exclude other units, singular does not exclude plural. The terms such as “first”, “second” are used to represent the name rather than any specific order.

1. A method for reducing interference among Femtocells in a first access device of a first Femtocell, comprising the following steps:
a receiving step, wherein said first access device receives a first wireless signal periodically transmitted by a second access device of a second Femtocell, and said first wireless signal comprises characteristic information of said second access device;
a judging step, wherein said first access device judges whether the level of said first wireless signal exceeds a first pre-determined threshold and interferes at least one user terminal in said first Femtocell;
a first executing step, wherein, if the level of said first wireless signal exceeds said pre-determined threshold and interferes said at least one user terminal in said first Femtocell, said first access device creates a cooperative working mode between said first access device and said second access device by interacting with said second access device, so as to reduce interference between said first Femtocell and said second Femtocell.

2. The method according to claim 1, wherein, after said receiving step, the method further comprises:
determining at least one parameter at air interface of said first access device according to the level of said first wireless signal.

3. The method according to claim 1, wherein, after said first receiving step, the method further comprises:
a connection establishing step, wherein said first access device establishes a connection between said first access device and said second access device over backhaul according to the characteristic information of said second access device in said first wireless signal;
said first executing step further comprises:
if the level of said first wireless signal exceeds said first pre-determined threshold and interferes said at least one user terminal of said first Femtocell, said first access device interacts with said second access device via said connection established over backhaul so as to create said cooperative working mode between said first access device and said second access device.

4. The method according to claim 1, wherein, said cooperative working mode comprises at least one of the following:
said second access device uses a beamforming scheme to reduce interference to said at least one user terminal;
said first access device, said second access device, said at least one user terminal and other user terminals of said second Femtocell which occupy the same transmission resources with said at least one user terminals perform downlink transmission using Multi-BS MIMO;
said first access device re-schedules said at least one user terminal so as to avoid interference from said second access device;
said second access device re-schedules said other user terminals so as to avoid interfering said at least one user terminals;
said second access device reduces transmission power when transmitting signals to said other user terminals so as to reduce interference to said at least one user terminal.

5. The method according to claim 1, wherein said first access device uses closed subscriber group to control the access at its air interface, and said first executing step further comprises:
obtaining characteristic information of each user terminal in said second Femtocell;
adding said characteristic information of each user terminal in said second Femtocell into the closed subscriber group controlled by said first access device.

6. The method according to claim 1, wherein said second access device uses closed subscriber group to control the access at its air interface, and said first executing step further comprises:
transmitting characteristic information of each user terminal in said first Femtocell to said second access device so that said second access device updates the closed subscribe group used by said second access device accordingly.

7. The method according to claim 1, wherein, the method further comprises:
a transmitting step, wherein said first access device periodically transmits a second wireless signal which comprises characteristic information of said first access device.

8. The method according to claim 7, further comprising:
a second executing step, wherein said first access device creates a cooperative working mode between said first access device and said second access device based on an interaction initiated by said second access device, so as to reduce the interference between said first Femtocell and said second Femtocell.

9. A first apparatus in a first access device of a first Femtocell for reducing interference among Femtocells, comprising:
a receiver, for receiving a first wireless signal periodically transmitted by a second access device of a second Femtocell, wherein said first wireless signal comprises characteristic information of said second access device;
a first unit, for judging whether the level of said first wireless signal exceeds a first pre-determined threshold and interferes at least one user terminal of said first Femtocell;
a second unit, for creating a cooperative working mode between said first access device and said second access device by interacting with said the second access device, so as to reduce interference between said first Femtocell and said second Femtocell, if the level of said first wireless signal exceeds said pre-determined threshold and interferes said at least one user terminal of said first Femtocell.

10. The first apparatus according to claim 9, further comprising:
a third unit, for establishing a connection between said first access device and said second access device over backhaul according to the characteristic information of said second access device in said first wireless signal;
said second unit is further used for:
if the level of the first wireless signal exceeds said first pre-determined threshold and interferes said at least one user terminal of said first Femtocell, said first access device interacts with said second access device via the connection established over backhaul so as to create said cooperative working mode between said first access device and said second access device.

11. The first apparatus according to claim 9, wherein, said cooperative working mode comprises at least one of the following:
said the second access device uses a beamforming scheme to reduce interference to said at least one user terminal;
said first access device, said second access device, said at least one user terminal and other user terminals of said second Femtocell which occupy the same transmission resources as said at least one user terminal perform downlink transmission using Multi-BS MIMO;
said first access device re-schedules said at least one user terminal so as to avoid interference from said second access device;
said second access device re-schedules said other user terminals so as to avoid interfering said at least one user terminal;
said second access device reduces transmission power when transmitting signals to said other user terminals, so as to reduce interference to said at least one user terminals.

12. The first apparatus according to claim 9, wherein said first access device uses closed subscribe group to control the access at its air interface, and said second unit comprises:
a first element, for obtaining characteristic information of each user terminal in said second Femtocell;
a second element, for adding said characteristic information of each user terminal in said second Femtocell into the closed subscribe group controlled by said first access device.

13. The first apparatus according to claim 9, wherein said second access device uses closed subscribe group to control the access at its air interface, and said second unit further comprises:
a first transmitter, for transmitting characteristic information of each user terminal of said first Femtocell to said second access device so that said second access device updates the closed subscribe group used by said second access device accordingly.

14. The first apparatus according to claim 9, wherein, further comprising:
a second transmitter, for periodically transmitting a second wireless signal which comprises characteristic information of said first access device.

15. The first apparatus according to claim 14, further comprises:
a fourth unit, for creating a cooperative working mode between said first access device and said second access device based on an interaction initiated by said second access device, so as to reduce the interference said first Femtocell and said second Femtocell.
